(19) United States
(12) Patent Application Publication
(10) Pub. No.: US 2021/0091476 A1
(43) Pub. Date: Mar. 25, 2021

(54) COMPACT WIDEBAND SLOT ANTENNA DESIGN WITH INVERTED CO-PLANAR WAVEGUIDE FEED

(71) Applicant: Mano D. Judd, Heath, TX (US)

(72) Inventor: Mano D. Judd, Heath, TX (US)

(21) Appl. No.: 16/582,061

(22) Filed: Sep. 25, 2019

(51) Int. Cl. H01Q 13/10; H01Q 1/52; H01Q 1/48

(52) U.S. Cl. CPC H01Q 13/10; H01Q 1/48; H01Q 1/52

(57) ABSTRACT

A slot antenna where the inner CPW trace is migrated to the inside of the slot, rather than being external to the slot, and thus inverts the polarity of the center trace and puts the CPW feed section inside (within) the slot structure itself. Therefore, in this novel embodiment, the CPW feed does not increase the net size of the antenna, and results in a much smaller and/or compact design. In this fashion, now both the outer conducting surface and the CPW trace are connected and both negative (ground) polarity, whereas the tuning element is positive polarity. Thus the inner CPW trace becomes the same polarity as the outer ground conducting surface. This design is compact, without compromising an excessive amount of ground plane structure.

The present application claims priority to the earlier filed provisional application having Ser. No. 62/744,995, and hereby incorporates subject matter of the provisional application in its entirety.

### BACKGROUND

Slot antennas are equivalently “magnetic dipole antennas” which consist of a conductive surface or flat metal plate, with one or more slots (conductor hole) within the plate. When an inside edge is driven by an alternating current, the slot can radiate electromagnetic waves. The slot antenna is similar to electric dipole antennas; which radiate parallel with the long axis, however, a slot antenna has polarization perpendicular to the long axis. Wideband slot antennas can be characterized consisting of five (5) basic elements. The first (1) element is the outer conductive surface, or ground plane, that is often much larger than the slot itself. This conductive surface can be of many shapes such as circles, squares, or rectangles. This is often considered the “ground” polarity of the antenna since, for a perfectly performing slot antenna, the conductive surface or ground would be infinite in size. The second (2) component is the slot itself. There are many shapes and optimal designs for slots, especially with regards to obtaining wideband performance. The third (3) component is the feed. For planar, single layer (of metal) designs, the feed is usually a Co-Planar Waveguide (CPW) or some type of microstrip or stripline structure. The Co-Planar Waveguide feed allows for a truly fully single layer structure, in which all of the basic components of the antenna reside on or within a single layer of conductive material or metal. The fourth (4) element is the tuning element and the fifth element (5) is the slot gap. Elements (4) and (5) help to adjust the frequency tuning and matching of the radiating slot, to the transmission line. In many of the published wideband designs, elements (1) through (5) can take on various shapes and sizes, depending on the particular characteristics, such as maximum bandwidth, or antenna gain, that is most desired. In conventional designs, the ground plane (conducting surface) would be considered the negative polarity, while both the inner CPW trace as well as the tuning element would both be positive polarity.

In the conventional design, usually some type of bulkhead RF connector would be soldered or electrically connected to the CPW feed, at some point within the conducting surface (sheet).

The conventional wideband slot antennas can take up significant area due to their irregular shape and with the CPW and bulkhead running external to the antenna. There are circumstances where a more compact design is desired, in order to not compromise an excessive amount of the ground plane structure.

### BRIEF SUMMARY OF THE INVENTION

A half-wavelength rod like antenna, with a feed in the center, is denoted as a (electric) dipole antenna. However, if the same size flat piece of metal were cut from an infinite sheet of metal, this would form a slot antenna, denoted as the complementary to the dipole. Thus, the dipole antenna and slot antenna are complementary antennas. Both antenna types convert electromagnetic energy into voltage and current used by a following circuit. Dipole antennas radiate from their ends, with electrons moving and accelerating along the long axis. Therefore, the far field electric field lines from a dipole are parallel to, or polarized, in the same axis as the long axis, along the dipole legs. The electric field line directions and magnetic field line directions of the (electric) dipole antenna and slot antennas are interchanged. Another way to view this is that the electric and magnetic fields radiated from a slot antenna are 90 degrees rotated from the dipole antenna. Slot antennas radiate from the inner edges of the slot. Since it is impossible to build an infinite sized ground plane, to house the slot antenna, its fields, though rotated 90 degrees from the dipole antenna, will never be exactly equal to the (electric) dipole antenna.

To some practitioners, the dipole antenna is denoted as an “electric” antenna, since the electric field is polarized along the antenna's long axis, and its radiated magnetic field is then perpendicular to this axis. In contrast, the complementary slot antenna radiates its electric field in the same axis that the dipole radiates is magnetic field, and vice versa. Often, the slot antenna is denoted as a magnetic antenna, even though the strength of its radiated magnetic field is minor compared to the strength of its radiated electric field.

The typical narrowband slot antenna has an extremely similar length and width as its narrowband complementary dipole antenna. However, this is not the case when the model is migrated to very wideband antennas.

There are numerous designs for efficient and effective slot antennas. One of the latest designs from literature and publications is the wideband slot antenna, which also comes in many forms, sizes, and shape. For example, there are circular slots, elliptical slots, as well as square and rectangular slots. Each of these has their own collection of feeding types, and placement of the opposing feed structures, to excite the “gap”. This gap forms the capacitive source for the electric field lines. A recent design is the circular wideband slot antenna, with Co-Planar Waveguide (CPW) feed. This structure puts a CPW feed on the same single layer, of conductor (or metal), as the slot and joins both together using an tuning element or “inner (metallic) island” that forms a gap between the edge of the tuning element and the inner edge of the slot. Other technical names for this (tuning element) component, within the literature, are radiation element, and tuning stub. The center trace of the CPW feed transmission line connects to the tuning element, and brings the positive polarity current to the tuning element, while the slot ground plane and outer structure of the CPW transmission line forms the other, or negative or ground, polarity.

One problem with this structure is that the transmission line can often be long or comprise a great deal of the ground plane structure.

The Applicant's embodiment inverts the polarity of the center trace and puts the CPW feed section inside (within) the slot structure itself. Therefore, in this new design, the CPW feed does not increase the net size of the antenna, and therefore results in a much smaller and/or compact design.

The Applicant's embodiment migrates the inner CPW trace to the inside of the slot, rather than be external to the slot. In this fashion, now both the outer conducting surface and the CPW trace are connected and both negative (ground) polarity, whereas the tuning element is positive polarity. Thus the inner CPW trace becomes the same polarity as the outer ground conducting surface.

Alternatively, we can denote the CPW trace and the conducting surface now as positive polarity, and the tuning element as the negative polarity.

What has effectively changed between this embodiment and conventional designs is that the CPW inner trace is now connected to the outer ground plane and is equal polarity with the outer ground plane, and not the tuning element.

In this new embodiment, the gap between the tuning element and the CPW inner trace becomes the new source point. Thus, the RF connector would be put at the end of this location, again making the design very compact.

### BRIEF DESCRIPTION OF THE DRAWINGS

FIG. 1 shows a traditional single pole circular slot antenna fed with conventional Tuning Element connected to an external Co-Planar Waveguide (CPW) feed, with the CPW feed also connected to an RF (example: SMA) connector.

FIG. 2 shows a conventional single pole rectangular wideband monopole antenna with co-planar waveguide.

FIG. 3 illustrates the Applicant's single polarization compact slot antenna with an inverted Co-Planar Waveguide (CPW) feed within the Tuning Element.

FIG. 4 presents another variation of the Applicant's circular slot antenna with an inverted Co-Planar Waveguide (CPW) feed within the Tuning Element, whereas the outer (ground) conductor is also circular.

FIG. 5 illustrates the Applicant's dual pole design utilizing the circular slot antenna with the inverted Co-Planar waveguide feed.

### DETAILED DESCRIPTION AND BEST MODE OF IMPLEMENTATION

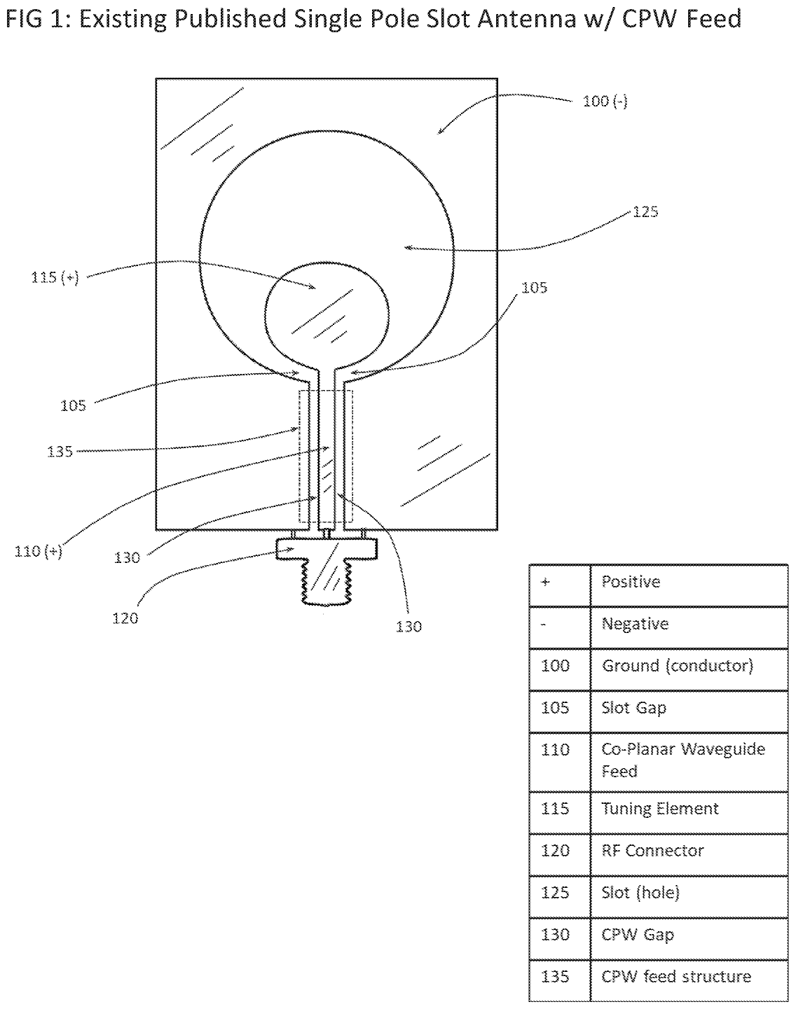

Wideband Slot antennas come in all sorts of sizes, shapes and configurations. However, single layer slot antennas, where all the conductive material or metal for the antenna is contained within a single flat or curved surface, require some variation of an external Co-Planar Waveguide (CPW) Feed structure. FIG. 1 shows a traditional single pole slot antenna fed with a conventional Tuning Element (115) connected to an external Co-Planar Waveguide (CPW) feed structure (135), with the CPW feed structure (135) also connected to an RF (example: SMA) connector (120). In this diagram, both the Slot (125) as well as the Tuning Element (115) are shown as circular shapes. In general, either or both of these components could be in almost any shape, including circular, elliptical, square, or rectangular. Additionally, the outer ground plane (100) outer edge dimensions could be almost any size or shape. However, the larger the ground plane (100), the better the antenna emulates the characteristics of its complementary electric dipole. All of the cases in the literature have the CPW feed structure (135) external to the slot (125). Additionally, the longer this feed length (110), the better the CPW feed (135) will tend to match the impedance of the RF connector (120) or coupling transmission line at the end. Therefore, the conventional CPW feed structure (135) is typically lengthed on the order or larger to the same size of the full slot (125). An advantage of slot antennas, is the small size of the slot (125), compared to the wavelength associated with the lowest desired operational frequency of the antenna. Typically, the inner dimensions of the wideband slot (125) are roughly 0.2 to 0.25 times the wavelength, at the lowest desired operational frequency of the antenna. This is therefore much smaller than the typical dimension of the complementary electric wideband dipole, which has a length between 0.3 and 0.5 wavelengths, at its lowest operation frequency, for the same radiation and gain characteristics. However, when adding in the additional CPW feed structure (135), and with length to provide good CPW feed transmission line performance, the complete structure will likely be much larger than the complementary electric dipole. In the FIG. 1 example, the ground plane (100) has been identified with negative voltage or polarity, while the tuning element (115) as well as the connecting CPW feed (110), both have positive voltage or polarity. This is simply an RF convention, and thus could be fully reversed. That is, for the same operation and performance, the ground plane (100) can have positive voltage or polarity, while the tuning element (115) as well as connecting CPW feed (110), both can have negative voltage or polarity.

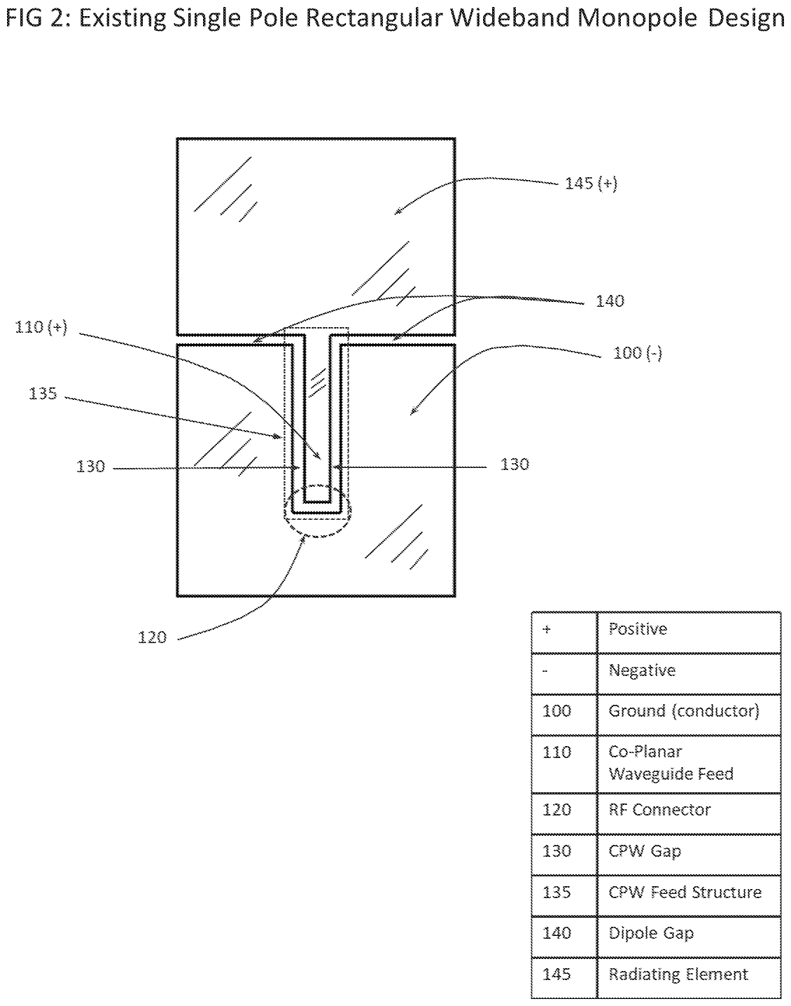

The antenna in FIG. 2 is actually not a slot antenna, but a Co-Planar Waveguide (CPW) fed monopole antenna. This antenna is being shown, since it has many similarities to the Wideband Slot Antenna with CPW feed. However, this is in fact a complementary antenna, e.g. similar to a Wideband Electric Dipole, and not a Wideband Slot Antenna. Additionally, it uses a similar feed mechanism to the Applicant's antenna embodiment. However, even though the feed (110) can be considered to be an inverted structure, the total structure of this antenna is dramatically different from any Wideband Slot Antenna with CPW feed, since the Wideband monopole radiates complementary to the Wideband Slot Antenna. That is, its electric and magnetic fields are 90 degrees rotated, to that of any Wideband Slot Antenna. Therefore, it should be clear to any person with expertise in the field, that the CPW feed is not inverted within a Tuning or Radiating Element. The Tuning Element (145) is here normally described, for an Electric Monopole Antenna, as a Radiating Element.

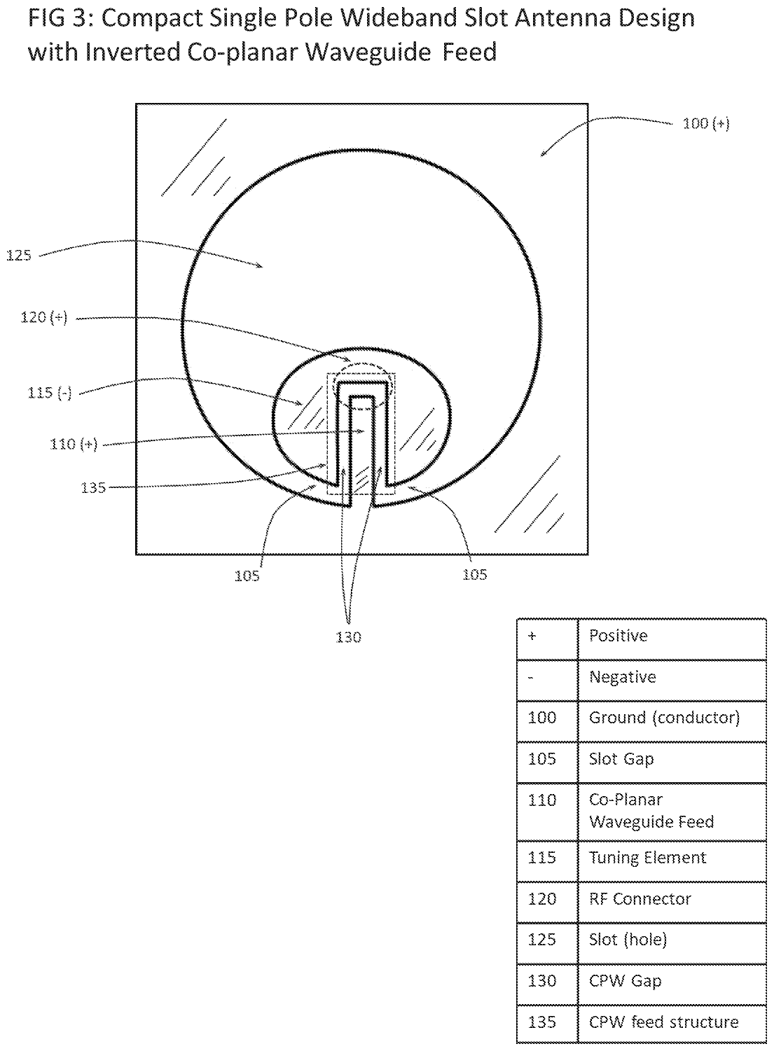

The general form of the novel Single Pole Compact Slot Antenna is shown in FIG. 3. All of the five basic components, from the system in FIG. 1, are also in this design. However, the CPW feed structure (135) is now completely contained within the Tuning Element (115), instead of within the Ground Plane (100). Additionally, the whole of an external CPW feed structure has been eliminated. In this sense, the feed of the antenna has been inverted. Similar to the conventional Wideband Slot Antenna design, from FIG. 1, that both or either the Slot or the Tuning Element can be of almost any shape, such as circular, elliptical, rectangular, square, or other shape. Of special notice is that now instead of the CPW feed strip (110) connecting to the Tuning Element (115) and to a connector at the far end of the Ground (plane, 100), as in the conventional design of FIG. 1, the CPW feed strip (110) now connects directly to the Ground plane (100). Additionally, the RF connector (120) is now moved from the edge of the Ground plane (100) to the inside of the Tuning Element (115). This inverted structure has now moved the entire CPW feed structure (135) as well as the RF connector/connection element (120) to within the slot, and has therefore reduced the size of the entire antenna structure by up to 2 or 3 times.

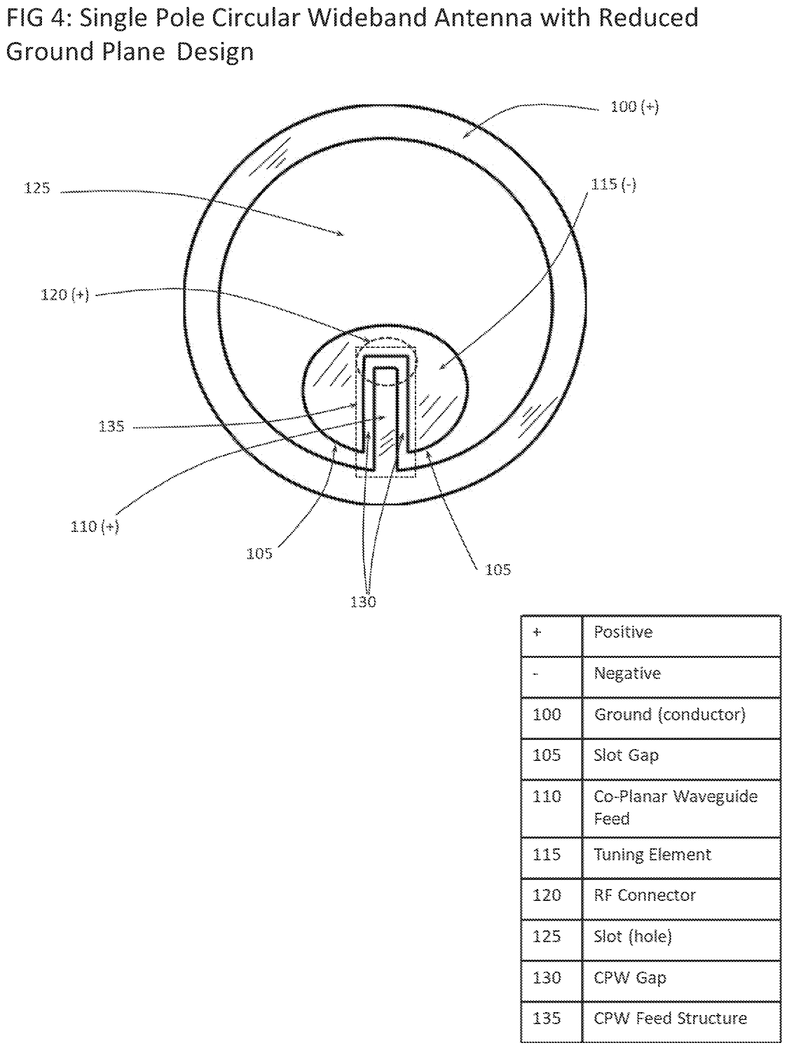

In the FIG. 4 embodiment, the ground plane (100) has been reduced in size. Additionally, for this embodiment, the shape of the ground plane (100) has been changed from rectangular or square, to circular. All that has changed is the size and shape of the outer ground plane (100). As long as there is sufficient ground plane (100) thickness, measured from the inside of the slot (125) the most outer edge of the ground plane (100), this antenna will still have adequate to good radiation patterns and gain. In this form, is the most compact Wideband Slot Antenna within a single layer of conductor (or metal), that can be achieved, yet still have equal to or similar radiation pattern and gain characteristics to the antenna of FIG. 1.

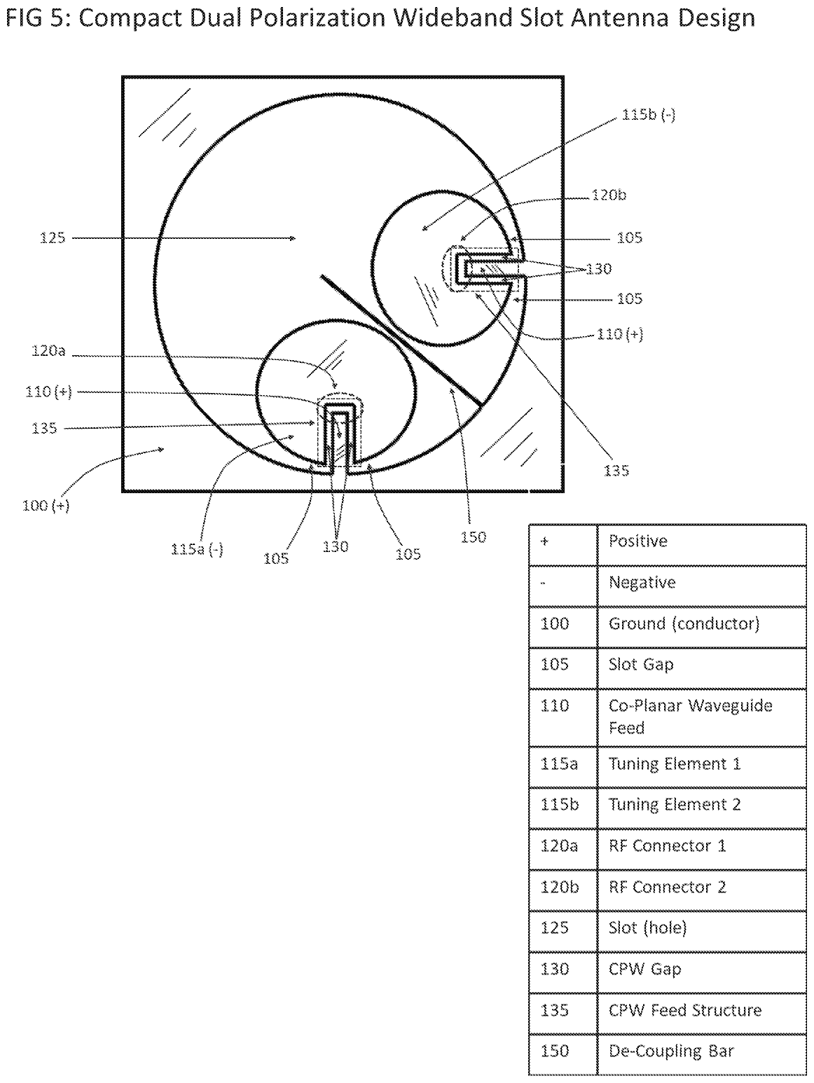

The Dual Polarization or Dual Element embodiment of this Compact Slot Antenna Design is shown in FIG. 5. This is officially denoted as a Compact Dual Polarization Wideband Slot Antenna. In this embodiment, two orthogonal Tuning Elements (115a and 115b) are contained within the Slot (125). The Tuning Elements (115a and 115b) as well as the inner (inverted) CPW feeds structures (135) can be identical to each other in size and/or shape, or could be different in size and shape, to accommodate different frequency or bandwidth characteristics for the radiation from each individual polarization. Additionally, each Tuning Element (115a and 115b) has its own and unique RF connector (120a and 120b) that provides a unique response to each individual signal polarization. In this configuration, the radiation from each Tuning Element (115a and 115b) has a radiation polarization orthogonal to each other. A de-coupling bar (150) is shown. This component simply helps to de-couple or isolate each Tuning Element (115a and 115b) from one another.

### REFERENCES

The following is a tabulation of some prior art that presently appears relevant:

U.S. Patents

| Patent Number | Application Number | Issue Date | Patentee |
|---|---|---|---|
| 5,061,943 | 388,098 | Oct. 29, 1991 | Rammos |

### Nonpatent Literature Documents

Li, Yu-Zhan et al. “A compact CPW-fed elliptical-slot UWB antenna with dual band-notched features.” Proceedings of the 9th International Symposium on Antennas, Propagation and EM Theory (2010): 181-184.
Azim, Rezaul and Mohammad Tariqul Islam. “Printed Wide Slot Ultra-Wideband Antenna.” (2013).
Angelopoulos, E. et al. “Circular and Elliptical CPW-Fed Slot and Microstrip-Fed Antennas for Ultrawideband Applications.” IEEE Antennas and Wireless Propagation Letters 5 (2006): 294-297.
G. P. Gao, M. Li et al. “Study of a Novel Wideband Circular Slot Antenna Having Frequency Band-Notched Function.” Progress in Electromagnetics Research, PIER 96 (2009): 141-154.

What is claimed is:

1. An antenna comprising:
an outer conducting surface or ground plane;
an internal slot or hole;
an internal tuning element structure within the slot;
a Co-Planar Waveguide within the internal tuning element which operates as the feed; and
a gap between the internal tuning element and the slot.

2. The antenna of claim 1 wherein the slot, the feed, the internal tuning element and the slot gap are all internally located within the outer conductive surface or ground plane.

3. The antenna of claim 1 wherein all elements of the total structure are comprised from a single layer of metal; and all provided on the same dielectric support surface or structure.

4. The antenna of claim 1 wherein the full structure can be planar or conformal to any surface.

5. The antenna of claim 1 wherein the outer conducting surface can be in any shape, including a circle, square, oval, or rectangle.

6. The antenna of claim 1 wherein the outer conducting surface is denoted as the ground polarity of the antenna.

7. The antenna of claim 1 wherein the inside edge of the internal slot forms the radiating elements for the antenna.

8. The antenna of claim 1 wherein the internal slot can be of any shape, including circular, elliptical, square, or rectangular.

9. The antenna of claim 1 wherein the Co-Planar Waveguide is inverted, and is internal to the tuning element within the slot; resulting in a compact structure.

10. The antenna of claim 1 wherein both the outer conducting surface and the Co-Planar Waveguide feed trace are connected, and are at the same polarity, whereas the tuning element is at the opposite polarity to both said Co-Planar Waveguide feed trace and said outer conducting surface of the slot antenna.

11. The antenna of claim 1 wherein the inverted Co-Planar Waveguide can also invert the polarity of said Co-Planar Waveguide, and changes the polarity such that the inner edge of the internal slot can be considered either a positive or negative polarity and the polarity of the internal tuning element would be of the opposite polarity.

12. A dual polarization antenna comprising
an outer conducting surface or ground plane;
two internal slots or holes;
two orthogonal internal tuning element structures within the slot;
a Co-Planar Waveguide within each internal tuning element which operates as the feeds; and
a gap between the internal tuning elements and the slots.

13. The dual polarization antenna of claim 12 wherein the internal tuning elements as well as the inverted inner co-planar waveguide feed structures can be identical to each other in size and shape, or could be different in size and shape, to accommodate different frequency or bandwidth characteristics for the radiation from each individual polarization.

14. The dual polarization antenna of claim 12 wherein each tuning element has its own and unique RF connector that provides a unique response to each individual signal polarization.

15. The dual polarization antenna of claim 12 wherein the radiation from each Tuning Element has a radiation polarization orthogonal to each other.

16. The dual polarization antenna of claim 12 wherein a de-coupling bar can be inserted to de-couple or isolate each tuning element from one another.

17. A method of constructing a compact slot antenna comprising:
providing an outer conducting surface or ground plane;
providing one or two internal slots or holes;
providing internal tuning element structures within the slot;
providing a Co-Planar Waveguide within each internal tuning element which operates as the feed; and
providing a gap between the internal tuning elements and the slots.

18. The method of claim 17 wherein the slot, the feed, the tuning element and the slot gap are all internally located within the outer conductive surface or ground plane.

19. The method of claim 17 wherein all elements of the total structure are comprised from a single layer of metal; and all provided on the same the dielectric support surface or structure.

20. The method of claim 17 wherein all elements of the total structure are comprised from a single layer of metal; and all provided on the same dielectric support surface or structure.

21. The method of claim 17 wherein the full structure can be planar or conformal to any surface.

22. The method of claim 17 wherein the outer conducting surface can be in any shape, including a circle, square, oval, or rectangle.

23. The method of claim 17 wherein the Co-Planar Waveguide is inverted, and is internal to the tuning element within the slot; resulting in a compact structure.

24. The method of claim 17 wherein both the outer conducting surface and the Co-Planar Waveguide feed trace are connected, and are at the same polarity, whereas the tuning element is at the opposite polarity to both said Co-Planar Waveguide feed trace and said outer conducting surface of the slot antenna.

25. The method of claim 17 wherein the inverted Co-Planar Waveguide can also invert the polarity of said Co-Planar Waveguide, and changes the polarity such that the inner edge of the internal slot can be considered either a positive or negative polarity and the polarity of the internal tuning element would be of the opposite polarity.
